(19) United States
(12) Patent Application Publication
(10) Pub. No.: US 2020/0122408 A1
(43) Pub. Date: Apr. 23, 2020

(54) HIGH SPEED AND NO EXCESS WELD FLASH VINYL WELDER

(71) Applicant: Patrick Terence Greller, Westlake, OH (US)

(72) Inventor: Patrick Terence Greller, Westlake, OH (US)

(21) Appl. No.: 16/167,663

(22) Filed: Oct. 23, 2018

(51) Int. Cl. B29C 65/24; B29C 65/78; B29C 65/00; E06B 3/96

(52) U.S. Cl. CPC B29C 65/245; B29C 65/7802; B29L 2031/005; B29C 66/80; E06B 3/9604; B29C 65/7844

(57) ABSTRACT

An apparatus for manufacturing rectangular frames of plastic material includes an apparatus frame and welding heads. A material clamp cooperates with an associated frame member to hold the associated frame member in a desired location during a frame assembly operation. A heat plate is movably attached to each welding head. The heat plate can be selectively positioned to an operating position. The material clamp positions the associated frame member in close proximity to the heat plate to heat a set of ends of the associated frame member utilizing only radiation and convection of heat developed by the heat plate. The plurality of welding heads exert pressure on adjoining associated frame members after the heat plate is removed from the operating position in order to weld the adjoining associated frame members together to form a rectangular frame.

### CROSS-REFERENCE TO RELATED APPLICATIONS

This application claims priority to U.S. Provisional Patent Application No. 62/575,676, filed on Oct. 23, 2017, the entire disclosure of which is hereby incorporated by reference.

### BACKGROUND OF THE DISCLOSURE

### Field of the Disclosure

The present disclosure relates to manufacturing rectangular frames of plastic material, for example, vinyl casements, door frames, and window frames and specifically relates to manufacturing rectangular frames of plastic material without flashing and with decreased cycle times.

### Discussion of Prior Art

In past disclosures, machines for welding vinyl window sashes or frames have been provided. However, these known machines faced a number of problems including, but not limited to, excess weld flash, the need to remove weld flash from finished window sashes or frames, slow speeds, long cycle times to weld, etc. As such, improvements are desired, and the present disclosure addresses at least some of these drawbacks of the prior disclosures.

### BRIEF SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

In an example, an apparatus for manufacturing rectangular frames of plastic material includes an apparatus frame. The apparatus also includes a plurality of welding heads movably mounted to the apparatus frame. More than one welding head of the plurality of welding heads is movable relative to the apparatus frame and more than one welding head of the plurality of welding heads is movable relative to each of the other welding heads. The apparatus further includes a material clamp mounted to each welding head. The material clamp cooperates with an associated frame member to hold the associated frame member in a desired location during a frame assembly operation. The apparatus still further includes a heat plate movably attached to each welding head. The heat plate can be selectively positioned to an operating position. The material clamp move relative to each of the welding heads to position the associated frame member in close proximity to the heat plate while the heat plate is in the operating position. The movement to the close proximity to the heat plate is in order to heat a set of ends of the associated frame member utilizing only radiation and convection of heat developed by the heat plate. The plurality of welding heads exert pressure on adjoining associated frame members after the heat plate is removed from the operating position in order to weld the adjoining associated frame members together to form a rectangular frame.

In an example, a method of fabricating the corner of a plastic window frame includes providing an apparatus for manufacturing rectangular frames of plastic material. The method also includes loading a plurality of associated frame members into the apparatus. The method further includes locating the plurality of associated frame members. The method still further includes selectively securing the plurality of associated frame members. The method also includes removing material from at least one associated frame member of the plurality of associated frame members. The method further includes heating a set of ends of the plurality of associated frame members utilizing only radiation and convection of heat developed by a heat plate. The method still further includes moving the set of ends of the plurality of associated frame members into contact each other. The method also includes holding the ends of the plurality of associated frame members in contact during a cooling cycle. The method further includes releasing the plurality of associated frame members for an unloading process.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a perspective view of an apparatus for manufacturing rectangular frames according to at least one embodiment of the present disclosure;

FIG. 2 is a perspective view of a welding head of the apparatus of FIG. 1;

FIG. 3 is a detail view of the welding head taken along line 3-3 of FIG. 1 showing locating members (e.g., material clamps) not holding associated frame members;

FIG. 4 is similar to FIG. 3 showing locating members holding associated frame members;

FIG. 5 is a detail view of the welding head of FIG. 2 showing a cutting device in position to remove material from the associated frame members;

FIG. 6 is a detail view of the welding head of FIG. 2 showing the heat plate in an operating position;

FIG. 7 is similar to FIG. 6 showing the heat plate in the operating position;

FIG. 8 is a detail view of the welding head of FIG. 2 showing the locating members holding the associated frame members in a welding position during a welding operation;

FIG. 9 is similar to FIG. 8 showing the locating members holding the associated frame members in a welding position during a welding operation;

FIG. 10 is a detail view of the welding head of FIG. 2 showing the material clamps in an open position after the welding operation to release the finished frame;

FIG. 11 is similar to FIG. 10 showing the material clamps in the open position; and

FIG. 12 is a top-down flow chart representing method steps of operating an apparatus for manufacturing rectangular frames.

### DETAILED DESCRIPTION

The claimed subject matter is now described with reference to the drawings. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

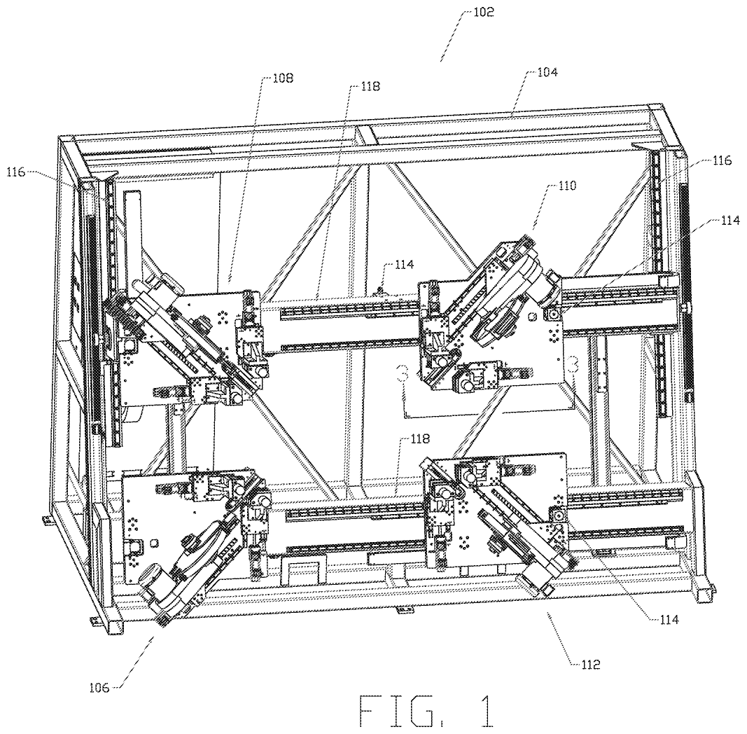

Referring to FIG. 1, an apparatus 102 for manufacturing rectangular frames of plastic material is shown. For the purposes of this disclosure, the term “plastic material” can include, but is not limited to, vinyl, polyvinyl chloride (PVC), polyurethane, ABS/ASA, cellular PVC, etc. The apparatus 102 can include machinery and controls used to create rectangular frames for structures such as sashes, window frames, door frames, and the like. The apparatus 102 includes an apparatus frame 104 that provides a rigid base for a plurality of welding heads 106, 108, 110, and 112. As in the shown example, there can be four welding heads 106, 108, 110, and 112 wherein one of the welding heads is stationary. For example, welding head 106 can be stationary and provide a known location which can serve as an origin for accurate coordinate measuring of lengths of associated frame components that will be described below.

The apparatus 102 includes a plurality of motion devices 114. In an example, a single motion device 114 is connected to (e.g., mounted to) an individual welding head. For example, one motion device 114 is mounted to each of the welding heads 110 and 112. Any suitable motion device 114 is contemplated, but an example motion device is a servo motor. The servo motor can apply a force to selectively move (e.g., position) the welding head. In the illustrated example, two welding heads 108, 110 are supported by a slide or slides 116 attached to the apparatus frame 104. The slide 116 can guide the welding heads 108, 110 as they are individually urged into motion by the motion devices 114. In the shown example, the motion devices 114 can selectively translate welding heads 108, 110 toward and away from stationary welding head 106. In the figure, the described translation of “toward and away” for the combination of welding heads 108, 110 is generally represented in the up and down directions of FIG. 1 (e.g., generally vertical motion).

Similarly, the welding heads 110, 112, can be supported by a slide or slides 118 attached to the apparatus frame 104. The slide 118, can guide the welding heads 110, 112 as they are individually urged into motion by the motion devices 114. In the shown example, the motion devices 114 can selectively translate welding heads 110, 112 toward and away from stationary welding head 106. In the figure, the described translation of “toward and away” for the combination of welding heads 110, 112 is generally represented in the right and left directions of FIG. 1 (e.g., generally horizontal motion). As shown in FIG. 1, the stationary welding head 106 can be the welding head in the lower left corner of the apparatus 102, however, this is only an example, and the stationary welding head can be located at any of the other positions shown in FIG. 1.

A plurality of welding heads 106, 108, 110, 112 are mounted to the apparatus frame 104 as previously described. More than one welding head (e.g., 108, 110, 112) of the plurality of welding heads 106, 108, 110, 112 is movable relative to the apparatus frame 104 and more than one welding head 108, 110, 112 of the plurality of welding heads is movable relative to each of the other welding heads 108, 110, 112. As previously described, this enables the stationary welding head 106 to provide a known location which can serve as an origin for accurate coordinate measuring of lengths of associated frame components that will be described below.

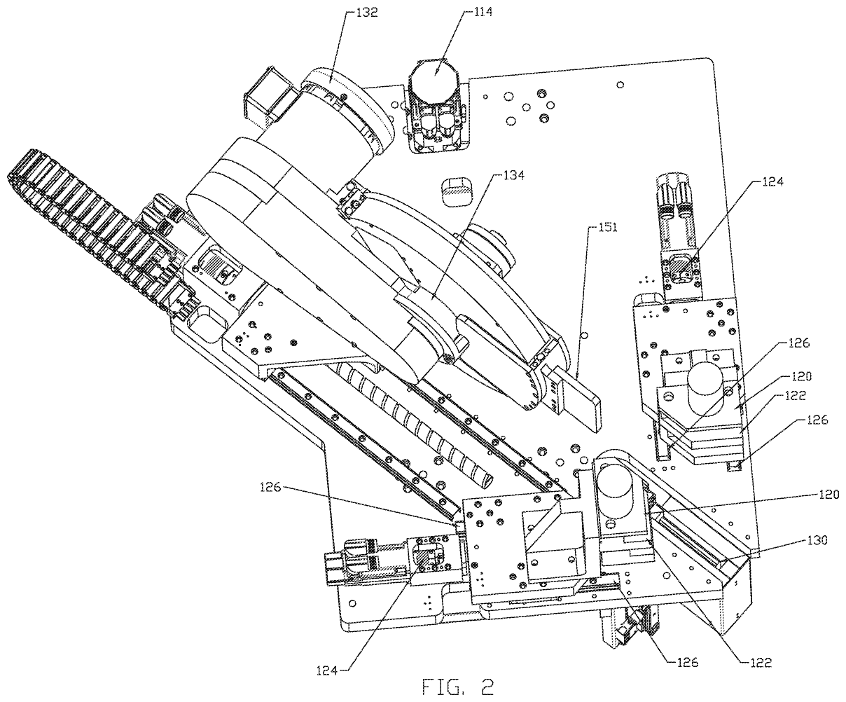

Referring to FIG. 2, a perspective view of a welding head is shown, and the example welding head can represent any of the welding heads 106, 108, 110, 112. For the purposes of simplicity, the example welding head shown in FIG. 2 is labeled 110. The apparatus 102 includes a material clamp 120 mounted to each welding head 110. The material clamp 120 cooperates with an associated frame member that will be discussed below to hold the associated frame member in a desired location during a frame assembly operation. As shown, the material clamp 120 includes a set of jaws 122 that can be urged together to clamp on an associated frame member and urged away from one another to release an associated frame member or a welded frame. Both of these motions (e.g., clamping and un-clamping) are generally perpendicular to a plane defined by the apparatus frame 104 (shown in FIG. 1). As shown in FIG. 2, each welding head 110 can include two material clamps 120. Each material clamp 120 is dedicated to holding an associated frame member that will be welded with another associated frame member to create a right angle of associated frame members that will become part of a finished, welded frame. In an example, the material clamps 120 on each welding head 110 are oriented perpendicular to each other in order to hold the associated frame members that are perpendicular to one another.

Remaining with FIG. 2, each material clamp 120 can include a motion device 124 (e.g., a servo motor). The motion device 124 can be selectively operated by a controller (not shown) to urge the material clamp 120 along a guide 126. In an example, the motion device 124 is a servo motor, as the servo motor can provide suitable control and location accuracy for the frame welding process.

The apparatus 102 further includes a heat plate 130 (shown in FIG. 2 and other Figures) movably attached to each welding head 110. The heat plate 130 can be selectively positioned to an operating position from a non-operating position or multiple non-operating positions. In an example, a motion device (not shown) can urge the heat plate 130 in a translational direction such that the operating position consists of the heat plate 130 in a position between the associated frame members and the non-operating position consists of the heat plate 130 being below the structure of the welding head 110. Any suitable motion device can be used to translate the heat plate 130 between the operating and non-operating positions.

The heat plate 130 can be constructed of any suitable material that can withstand the operational and temperature demands of the apparatus 102. In an example, the heat plate 130 includes a metal material. In an example, the heat plate 130 includes an aluminum bronze material or alloy.

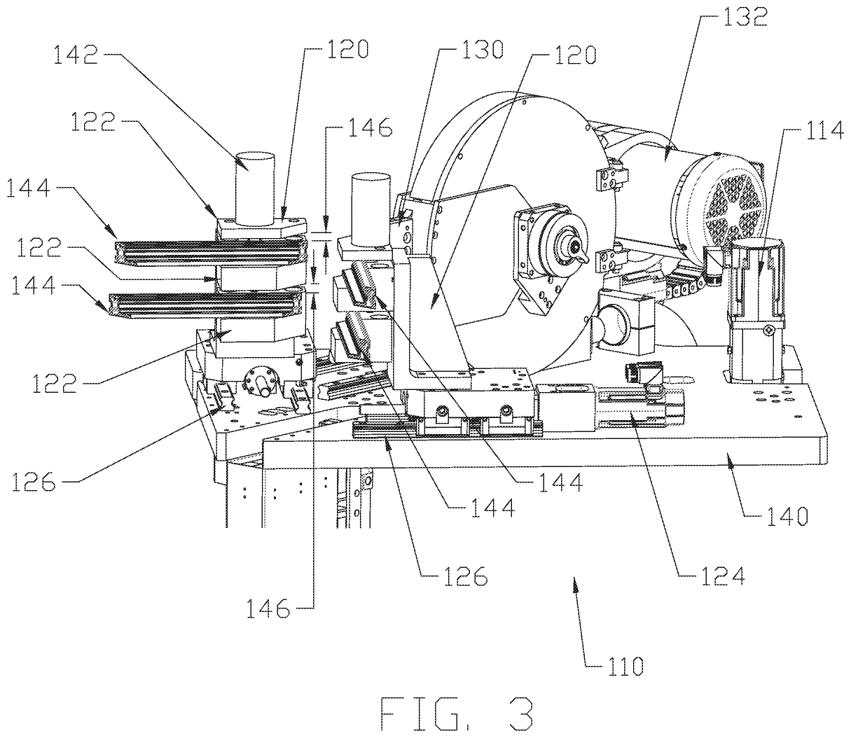

Referring to FIG. 3, a detail view of the welding head 110 taken along line 3-3 of FIG. 1, which is generally parallel to a plane formed by the apparatus frame 104 (shown in FIG. 1). The welding head can include mounting plate 140 which serves as a structure upon which to mount each operating component of the welding head 110 and maintain known distances between each of the operating components. For example, the welding head 110 includes the motion device 114. The welding head 110 further includes the material clamps 120 and their associated motion devices 124 and guides 126. The heat plate 130 is also mounted to the welding head 110, although it is partially hidden behind the material clamp 120 on the right.

Remaining with FIG. 3, the material clamps 120 can further include during the frame manufacturing process motion devices 142 which can selectively urge the set of jaws 122 toward a clamped position and an unclamped position. As shown in FIG. 3, the material clamps 120 and the sets of jaws 122 are in the unclamped position such that a set of associated frame members 144 can be freely moved with respect to the material clamps 120. The unclamped position is representative of the existing gaps (represented by dimension 146) between the jaws 122 and the associated frame members 144. While dimension 146 is shown only once in FIG. 3, each of the sets of jaws 122 can have gaps 146 of the same or similar magnitude. It is to be understood that the associated frame members 144 shown in this and other figures are shortened for clarity purposes, and the actual associated frame members 144 extend to the next welding head.

Any suitable motion devices 142 can be used to urge the sets of jaws 122 from the clamped to an unclamped position. In an example, the motion device 142 is an air cylinder that is controlled by a controller (not shown). It is to be understood that the amount of force placed upon the associated frame members 144 during the clamping process will not permanently deform the associated frame members 144 or otherwise distort the proportions of the frame members 144 during the manufacturing process.

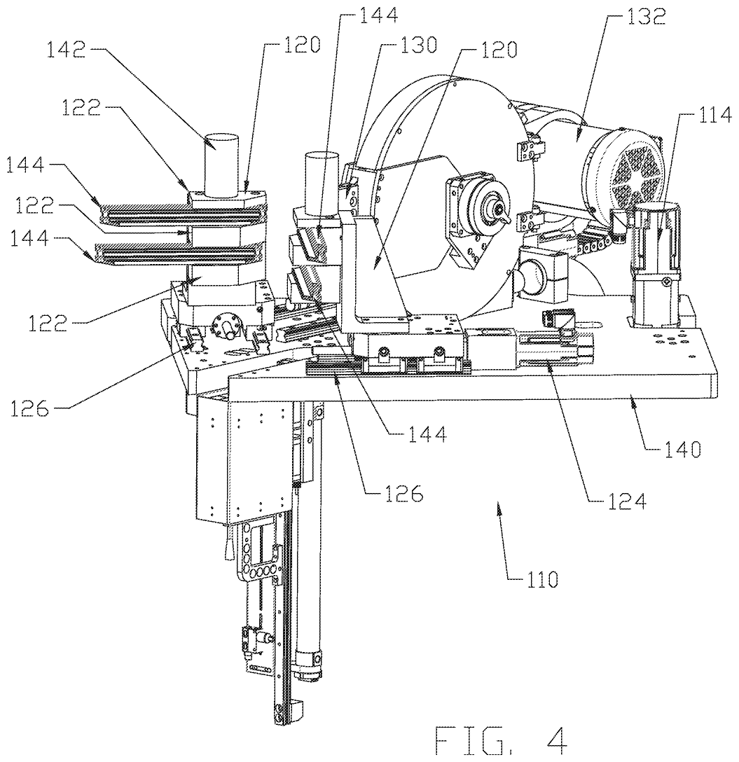

Referring to FIG. 4, the welding head 110 is shown in the same view as FIG. 3, but with the sets of jaws 122 in a clamped position as opposed to the unclamped position of FIG. 3. As shown, the gap 146 of FIG. 3 has been eliminated as the sets of jaws 122 closed on the associated frame members 144. The sets of jaws 122 may be changed with individual profiles of associated frame members 144. With the associated frame members 144 clamped into place, inadvertent movement of the associated frame members 144 is limited and/or eliminated.

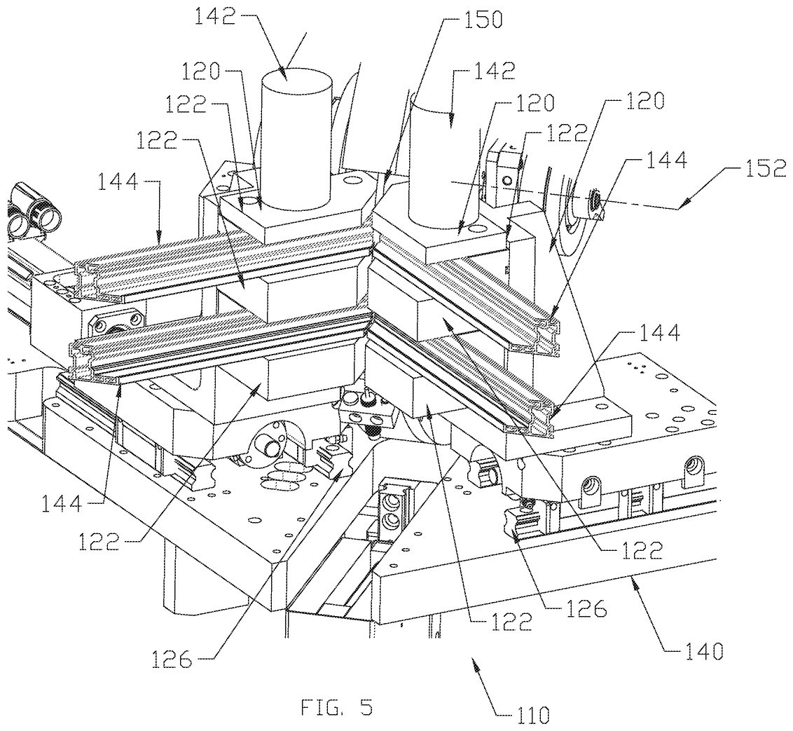

Referring to FIG. 5, the associated frame members 144 have been drawn together in preparation for a cutting operation. In an example, a gap is maintained between the associated frame members 144 as shown in FIG. 5, however, other examples are contemplated where the associated frame members 144 can be brought into contact with one another prior to the cutting operation. The welding head 110 welder may then machine the associated frame members 144. To this end, the welding head 110 includes a cutting device 150 attached to the welding head 110 to remove material from the associated frame members 144. Any suitable cutting device is acceptable, however in one example, the cutting device 150 is a rotating blade which rotates about axis 152. In an example, a motion device 132 can urge the cutting device 150 in a rotational direction. Any suitable motion device 132 can be used including, but not limited to, an electric motor. The motion device 132 can also be mechanically connected to the cutting device 150 in any suitable manner. In an example, the motion device 132 can be attached to the cutting device 150 directly or indirectly through other mechanisms or structures such as belt drives, chain drives, etc. As shown in FIG. 2, a locator plate 151 can be attached to a forward portion of a guard that at least partially covers the cutting device 150.

Each associated frame member 144 is cut to a near net dimension prior to the welding process while it is mounted to the apparatus 102. While described for welding head 110, the cutting operation can happen simultaneously at all of the welding heads 106, 108, 110, 112. Furthermore, the cutting operation can cut the associated frame members in a bevel cut that is 45°, in preparation for welding two adjacent associated frame members in a right angle to form a portion of a rectangular or square frame. Also, the cutting operation can consist of the cutting device 150 cutting adjacent associated frame members 144 in one cut. In an example, the cutting device 150 can cut four associated frame members 144 in one cut.

In an example, the near net dimension is the final length prior to welding to the adjacent associated frame member 144. In an example, the near net dimension is a length oversize between about 0.002 inches (0.051 mm) and about 0.010 inches (0.25 mm). It is to be appreciated that the relative precision of the location of the associated frame members 144 enables the near net dimension to be altered for various chemical formulations that make up the associated frame members 144. In an example, one formulation of material may require less oversize length to produce little or no flash after heating and welding when compared to other formulations. As such, the location of the associated frame members 144 can be altered to optimize the near net dimension. In an example, this near net dimension can be determined experimentally. In an example, the controller (not shown) calculates the near net dimension based upon the formulation of the associated frame members 144. Otherwise, the desired near net dimension can be manually entered into the controller. In an example, the near net dimension can also be altered based upon the geometry of the individual window or sash frame that is being constructed.

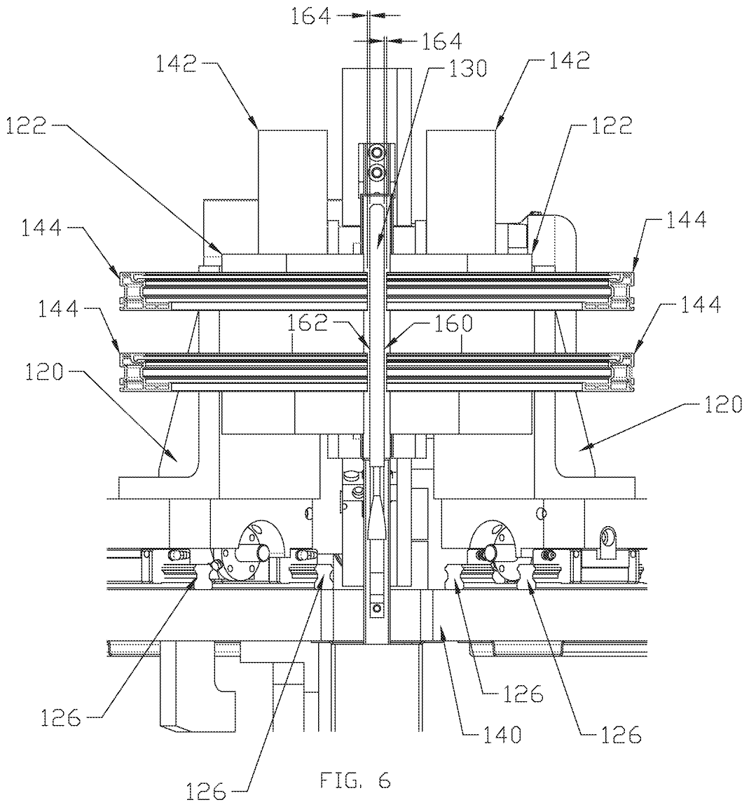

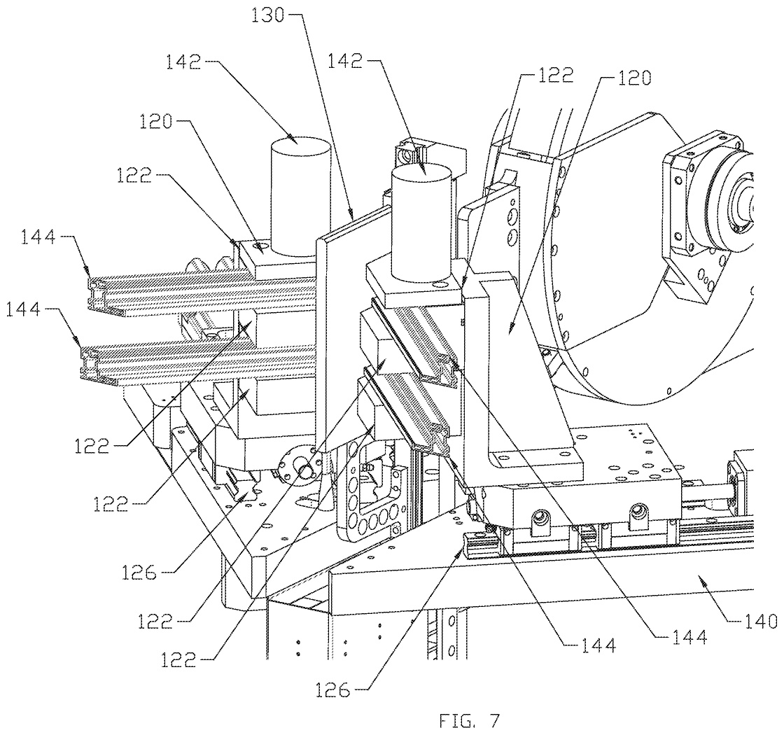

Referring to FIG. 6, after the described cutting operation, the heat plate 130 is rotated into an operating position as shown. In an example, the operating position for the heat plate 130 is at a position between two adjacent associated frame members 144. As shown in FIGS. 6 and 7, the heat plate 130 can be located such that opposing sides 160, 162 of the heat plate 130 are parallel or nearly parallel to the cut edges of the associated frame members 144. As such, the heat plate 130 can be positioned at a 45° angle to the sides of interior and exterior sides of the associated frame member 144.

The heat plate 130 can be heated to and operates at a temperature of between about about 800° F. (427° C.) and about 1100° F. (593° C.). In an example, the heat plate 130 operates at a temperature of between about 900° F. (482° C.) and about 1000° F. (538° C.). Similar to the near net dimension described above, the operating temperature of the heat plate 130 can be optimized to individual formulations of the associated frame members 144. The recited temperature range can be significantly higher than many known apparatus for manufacturing rectangular or square frames for windows and sashes. This decreases the time required to bring the ends of the associated frame members 144 to welding temperature and decreases the cooling time, as a reduced length of the associated frame members 144 are actually heated. This reduction in time can reduce the cycle time for the apparatus by 40% to 50% compared to known machines.

After the heat plate 130 is located in the operating position of FIGS. 6 and 7, the apparatus 102 moves the associated frame members 144 to positions relatively close to the heat plate 130, but not touching the heat plate 130. In an example, the motion devices 124 move the material clamps 120 on each welding head 106, 108, 110, 112 to move the associated frame member 144 to within a close proximity of the heat plate 130. In an example, the close proximity is within a distance between about 0.001-inch (0.0254 millimeter) and about 0.006-inch (0.1524 millimeter) of the heat plate 130 when the heat plate 130 is in the operating position. This separation distance is represented in FIG. 6 by dimension 164. This separation distance 164 enables heating of a set of ends of the associated frame member 144 utilizing only the effects of heat radiation, heat convection, and/or a combination of heat radiation and heat convection to heat a set of ends of the associated frame member 144. As such, the heat developed by the heat plate 130 heats the associated frame members 144 without creating contact between the heat plate 130 and the associated frame member 144.

In an example, the motion devices 124 move the material clamps 120 on each welding head 106, 108, 110, 112 to move the associated frame member 144 to within a distance between about 0.002-inch (0.0508 millimeter) and about 0.003-inch (0.1524 millimeter) of the heat plate 130 without having the associated frame member 144 touching the heat plate 130. Again, these small separation distances 164 are enabled by the relatively accurate and repeatable operation of the servo motors that urge movement of both the welding heads 108, 110, 112 and the material clamps 120. As with other operational parameters, the separation distance 164 can be optimized per the geometry of the particular frame being constructed and/or the formulation of the plastic or vinyl material constituting the associated frame member 144.

The controller (not shown) can include a timer that optimizes the time that the associated frame members 144 are in close proximity to the heat plate 130. At the end of the optimized time period, the heat plate 130 can be moved out of the operating position to a non-operating position. Welding head 110 in FIG. 1 shows an example of the heat plate 130 in a non-operating position.

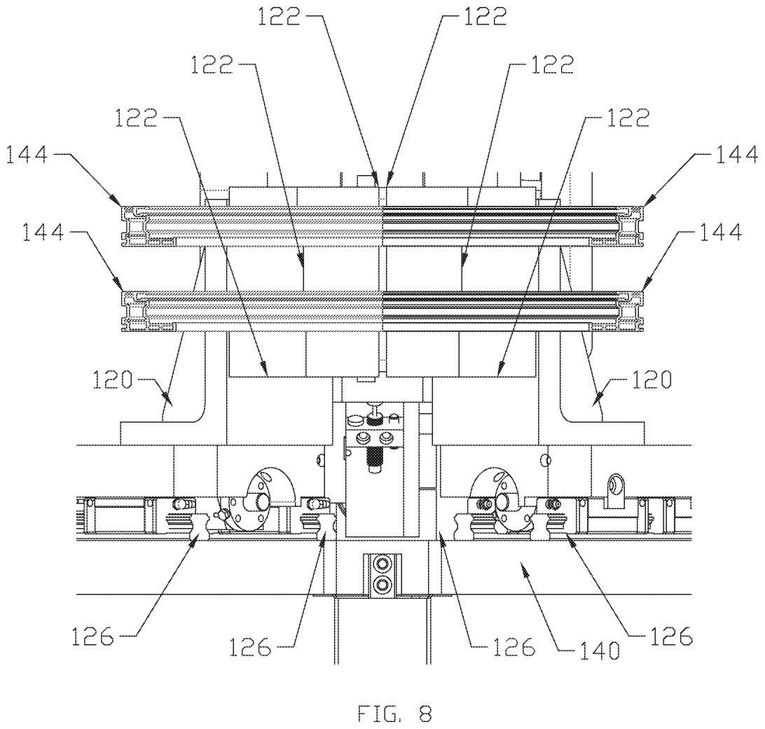

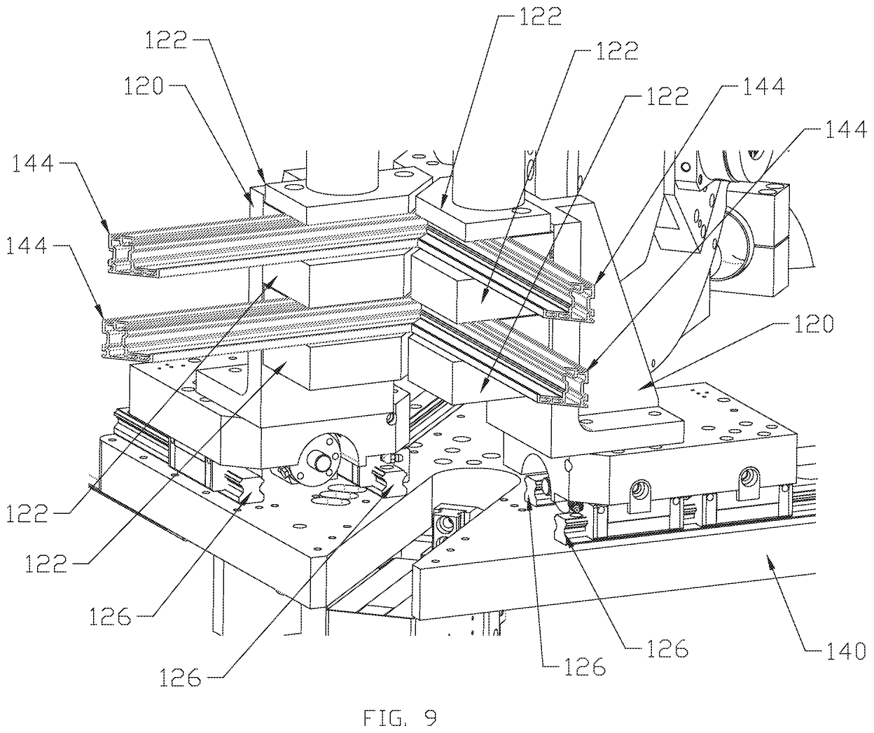

Referring to FIGS. 8 and 9, after the heat plate 130 (shown in FIGS. 6 and 7) is moved from the operating position, the apparatus 102 then moves the associated frame members 144 into contact with adjacent associated frame members 144 to form an angle (e.g., a right angle) that forms part of a finished window frame or a finished sash frame. Pressure is exerted and maintained on the adjacent associated frame members 144 in order to form a weld at the contact surfaces of the adjacent associated frame members 144. The controller can maintain a counter to limit the cool down period, the time of contact, and the pressure to optimize the weld characteristics and limit and/or eliminate any weld flash between the adjacent associated frame members 144.

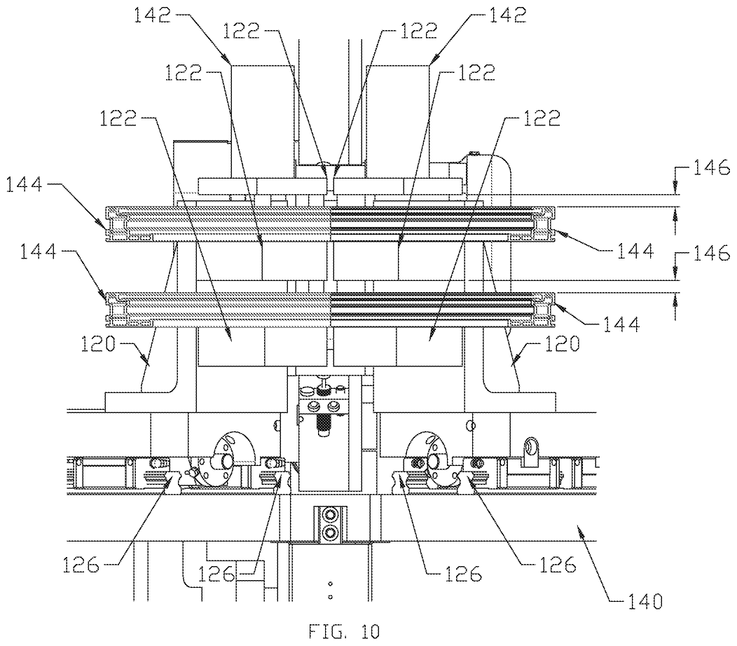

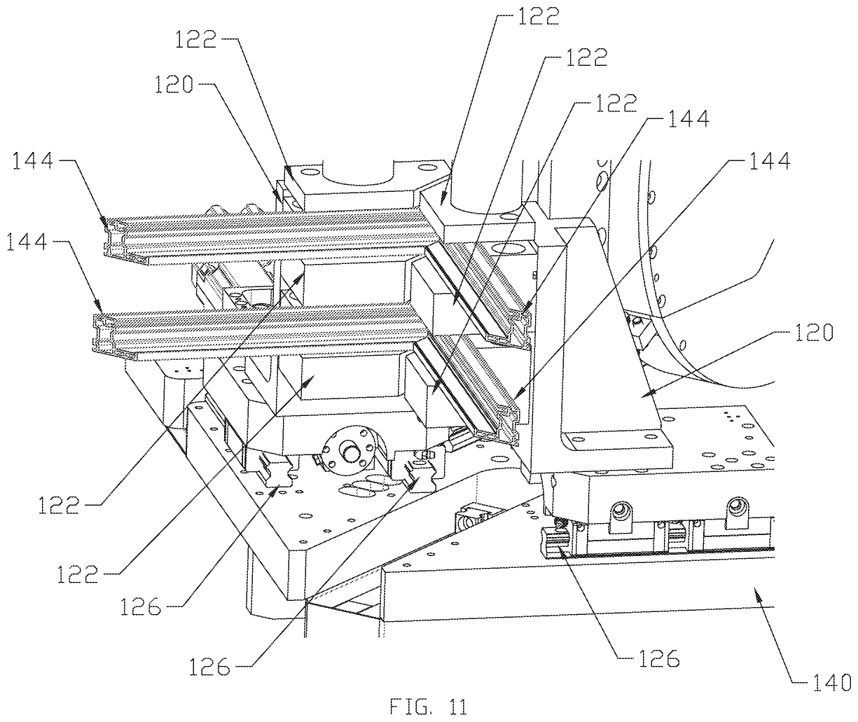

Referring to FIGS. 10 and 11, at the end of the cool down period, the motion devices 142 can urge the material clamps 120 to an unclamped position such that there is a gap 146 between the welded frame and the set of jaws 122. The welding heads 108, 110, 112 can then move away from the finished frame to release the frame from the tooling. An operator or an automated process can then retrieve the finished frame and move it to the next processing machine. It is to be understood that the finished frame has either minimal weld flash or no weld flash such that it is not necessary to remove any flash from the finished frame in a secondary operation that requires a specialized apparatus or hand work.

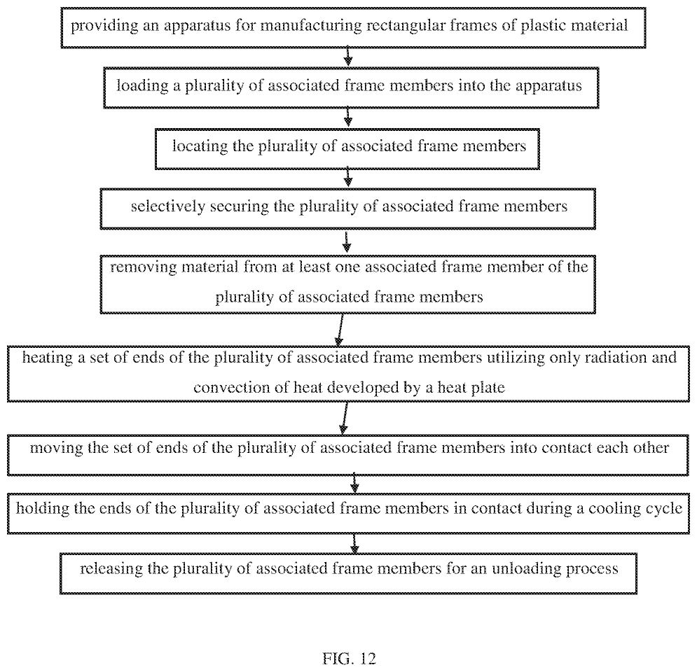

Referring to FIG. 12, a method for utilizing the described apparatus will now be discussed. First, one or more associated frame members may be loaded into the apparatus. In an example, the apparatus may comprise support structures or other devices to hold the associated frame members into place with respect to the welder. At this step, the associated frame members are relatively accurately located. Next, the apparatus can securely clamp the parts. In this way, inadvertent movement of the parts is limited and/or eliminated. The apparatus may then remove material from the associated frame members to machine the associated frame members to their final length (e.g., near net dimension). In this way, the associated frame members may be at their final size prior to welding.

Once the associated frame members have been machined, the apparatus can heat one or more portions of the associated frame members. For example, the apparatus can heat ends of the associated frame members that will contact the adjacent associated frame members. With the ends of the associated frame members heated, the apparatus can place the parts together and/or adjacent to each other and/or in contact with each other. This close placement of the associated frame members can be maintained for a period of time so as to allow for the welds to cool down in temperature. After the weld temperature has cooled down, the apparatus can release the finished parts.

It is noted that during the welding process, heat may be transferred to the vinyl through one or more means, such as radiation, convection, and/or a combination of radiation and convection. In this way, the vinyl may not contact the heat plate. In contrast to past attempts in which the vinyl needed to be cut to a final welding size prior to using the welder, the present application discloses a method of cutting the vinyl to a final welding size in the welder. The welder may be equipped with a saw, router, or other cutting instrument to machine the vinyl to a final welding size/length.

The vinyl welder can provide a number of benefits over known welders. For example, the described apparatus and methods can provide faster welding than currently available welders. In this way, the cycle time to weld a window sash or frame may be reduced. In addition, the vinyl welder can reduce and/or eliminate excess weld flash. Further, corner cleaning of the product may no longer be necessary after welding. Elimination of corner cleaning and flash removal machines can further reduce cycle times in the manufacturing process and can also reduce staffing needs in the manufacturing process. Each of these benefits can reduce the time and cost of manufacturing rectangular frames of various materials (e.g., plastic or vinyl). Another benefit can include less material waste. In other, known welders, the associated frame members have greater oversize dimensions prior to welding, and this extra material length (as much as ⅛-inch per end of vinyl) is turned into flash which is then machined away. Welding parts that are cut on the machine to near net dimensions as in the present disclosure can eliminate this waste, and thus reduce the cost of the finished product.

The term “exemplary” may be used herein to mean serving as an example, instance, illustration, etc., and not necessarily as advantageous. As used in this application, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, or variants thereof are used, such terms are intended to be inclusive in a manner similar to the term “comprising”.

Many modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first item and a second item may generally correspond to item A and item B or two different or two items or the same item.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular, regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

1. An apparatus for manufacturing rectangular frames of plastic material, comprising:
an apparatus frame;
a plurality of welding heads mounted to the apparatus frame, wherein more than one welding head of the plurality of welding heads is movable relative to the apparatus frame and more than one welding head of the plurality of welding heads is movable relative to each of the other welding heads;
a material clamp mounted to each welding head, the material clamp cooperates with an associated frame member to hold the associated frame member in a desired location during a frame assembly operation; and
a heat plate movably attached to each welding head, wherein the heat plate can be selectively positioned to an operating position,
wherein the material clamp moves relative to each of the welding heads to position the associated frame member in close proximity to the heat plate while the heat plate is in the operating position in order to heat a set of ends of the associated frame member utilizing only radiation and convection of heat developed by the heat plate,
wherein the plurality of welding heads exert pressure on adjoining associated frame members after the heat plate is removed from the operating position in order to weld the adjoining associated frame members together to form a rectangular frame.

2. The apparatus according to claim 1, wherein the heat plate is constructed of a metal.

3. The apparatus according to claim 2, wherein the heat plate is constructed of an aluminum bronze alloy.

4. The apparatus according to claim 1, wherein the heat plate operates between about 800° F. and about 1100° F.

5. The apparatus according to claim 1, wherein the heat plate operates between about 900° F. and about 1000° F.

6. The apparatus according to claim 1, wherein the movable welding heads of the plurality of welding heads move the associated frame member to within a distance between about 0.001-inch (0.0254 millimeter) and about 0.006-inch (0.1524 millimeter) of the heat plate when the heat plate is in the operating position without creating contact between the heat plate and the associated frame member.

7. The apparatus according to claim 1, wherein the plurality of welding heads move the associated frame member to within a distance between about 0.002-inch (0.0508 millimeter) and about 0.003-inch (0.1524 millimeter) of the heat plate without touching the heat plate.

8. The apparatus according to claim 1, further comprising a cutting device attached to each welding head of the plurality of welding heads.

9. The apparatus according to claim 8, wherein the cutting device cuts an associated frame member to a near net dimension.

10. The apparatus according to claim 1, wherein each welding head is a double-welding head wherein multiple material clamps are mounted to each welding head, the material clamps cooperate with multiple associated frame members to hold the associated frame members in a desired location during a frame assembly operation to create more than one rectangular frame during a single operation cycle.

11. The apparatus according to claim 1, further comprising a servo motor connected to more than one welding head of the plurality of welding heads, the servo motor applies a force to selectively position more than one welding head of the plurality of welding heads.

12. A method of fabricating the corner of a plastic window frame, said method comprising:
providing an apparatus for manufacturing rectangular frames of plastic material;
loading a plurality of associated frame members into the apparatus;
locating the plurality of associated frame members;
selectively securing the plurality of associated frame members;
removing material from at least one associated frame member of the plurality of associated frame members;
heating a set of ends of the plurality of associated frame members utilizing only radiation and convection of heat developed by a heat plate;
moving the set of ends of the plurality of associated frame members into contact each other;
holding the ends of the plurality of associated frame members in contact during a cooling cycle; and
releasing the plurality of associated frame members for an unloading process.

13. The method according to claim 12, wherein the apparatus further comprises:
an apparatus frame;
a plurality of welding heads movably mounted to the apparatus frame, wherein more than one welding head of the plurality of welding heads is movable relative to the apparatus frame and more than one welding head of the plurality of welding heads is movable relative to each of the other welding heads;
a material clamp mounted to each welding head, the material clamp cooperates with an associated frame member to hold the associated frame member in a desired location during a frame assembly operation; and
a heat plate movably attached to each welding head, wherein the heat plate can be selectively positioned to an operating position.

14. The method according to claim 13, wherein the heat plate operates between about 800° F. and about 1100° F.

15. The method according to claim 13, wherein the heat plate operates between about 900° F. and about 1000° F.

16. The method according to claim 13, wherein the step of heating a set of ends of the plurality of associated frame members includes moving the associated frame member to within a distance between about 0.001-inch (0.0254 millimeter) and about 0.006-inch (0.1524 millimeter) of the heat plate when the heat plate is in the operating position without creating contact between the heat plate and the associated frame member.

17. The method according to claim 13, wherein the step of heating a set of ends of the plurality of associated frame members includes moving the associated frame member to within a distance between about 0.002-inch (0.0508 millimeter) and about 0.003-inch (0.1524 millimeter) of the heat plate without touching the heat plate.

18. The method according to claim 13, wherein the apparatus further comprises a cutting device attached to each welding head of the plurality of welding heads.

19. The method according to claim 18, wherein the cutting device cuts an associated frame member to a near net dimension.
